(19) United States
(12) Patent Application Publication
(10) Pub. No.: US 2005/0226768 A1
(43) Pub. Date: Oct. 13, 2005

(54) Test plates to rapidly siphon and transfer the blood

(76) Inventors: Chang-Hai Chen, Hsin Chu City (TW); Hui-Tsung Tseng, Hsin Chu City (TW)

Correspondence Address: CHANG HAI CHEN, P.O. BOX 7-288, TAIPEI, TW

(21) Appl. No.: 10/822,284

(22) Filed: Apr. 12, 2004

(51) Int. Cl. B32B 27/04

(52) U.S. Cl. 422/58

(57) ABSTRACT

The present invention provides a new structure for test plates to rapidly siphon and transfer the blood, consisting of an upper plate, a lower plate, and two electrode plates, and the features including: a convex arc-shaped press area located on the front of the upper plate, the said area has a sucking hole on the top for blood suction where can receive drop of blood from fingertip. There are several triangular lattices of air holes built inward and around the external periphery of the sucking hole, so that when a finger is placed on the press area to force air out to release pressure and then the air hole will close immediately thereafter. This device is helpful by sucking the blood with the vacuum principle so as to rapidly siphon and transfer the blood for blood test.

### BACKGROUND OF THE INVENTION

As investigated, if use the first generation optical glucose blood meter, the finger pricking must be done prior to the test where the blood has to be in touched with the instrument and may increase the chance of cross infection. Today, the technology has been transformed from optics to electronics. Connecting one side of the plate to the electronic blood glucose meter, while the other side is used for blood analysis where the test blood is adhered to the edge of the plate and the blood will transfer into the electrode plate automatically after few seconds, and the glucose index can be obtained. Then, remove the plate and dispose it. In this case, the blood glucose meter will not get in touch with the blood directly, and thus significantly reduce the chance of cross infection. Additionally, such electronic blood glucose meter has other advantages such as requiring less quantity of blood, no wiping needed, high sensitivity, quick response, high accuracy, and lower price. If interact with other enzymes, this electronic instrument can be further developed for other useful tests such as the tests for uric acid, cholesterol, and triglyceride at home. However, since the test plate adopts electrode plate principle where blood will transfer into the plate automatically and that if the blood quality of the best blood is too thick or easily coagulated, it may affect test results directly. Further, since the product relates to the patient's health and safety, and the quality and accuracy of medical instruments and equipments set by the requirements of all countries are getting rigid, it is more than necessary for vendors to improve their products.

### SUMMARY OF THE INVENTION

The primary objective of the present invention is to provide a new structure for test plates to rapidly siphon and transfer the blood via a sucking hole located on the top of a convex arc-shaped press area of the upper plate. By pressing the sucking hole, the blood can be directly collected for safety and hygiene

The secondary objective of the present invention is to provide a new structure for test plates to rapidly siphon and transfer the blood. Around the external periphery of the sucking hole, there are several air holes for finger pressing so as to force the air to release pressure and the air hole will close immediately thereafter. Pressing the press area to force the air out to release pressure and then the air hole will close immediately thereafter.

Another objective of the present invention is to provide a new structure for test plates to rapidly siphon and transfer the blood, indicating that by pressing the top of sucking hole, with the structure of air holes and the vacuum principle to rapidly siphon and transfer the blood.

### BRIEF DESCRIPTION OF THE DRAWINGS

FIG. 1 is an illustration of the invention;

FIG. 2 is the illustration of the parts list of the invention;

FIG. 3 is the illustration demonstrating how the air will be released after pressing the press area and closed immediately thereafter;

FIG. 4 is the partial enlarged illustration of FIG. 3 of the invention;

FIG. 5 is the illustration demonstrating how the press area will suck the blood around the sucking hole.

### DETAILED DESCRIPTION OF THE PREFERRED EMBODIMENT

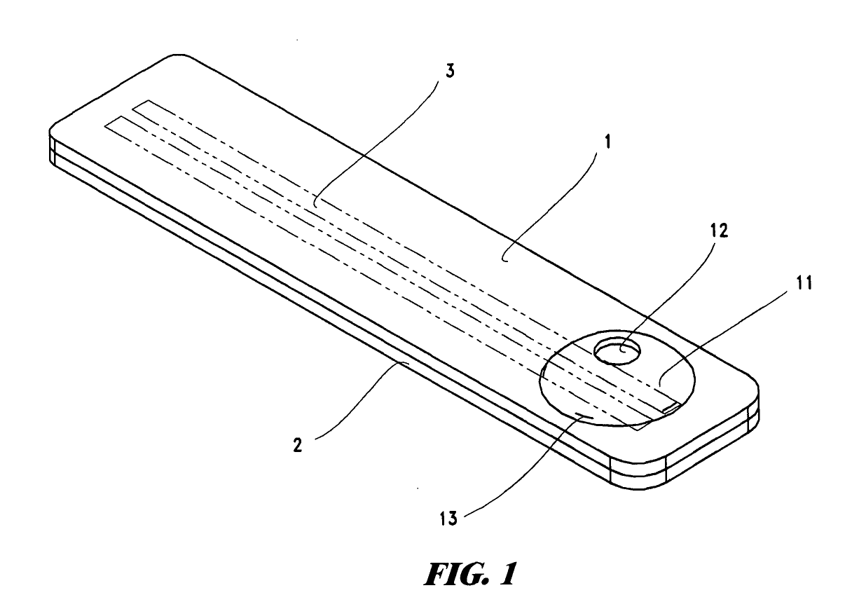

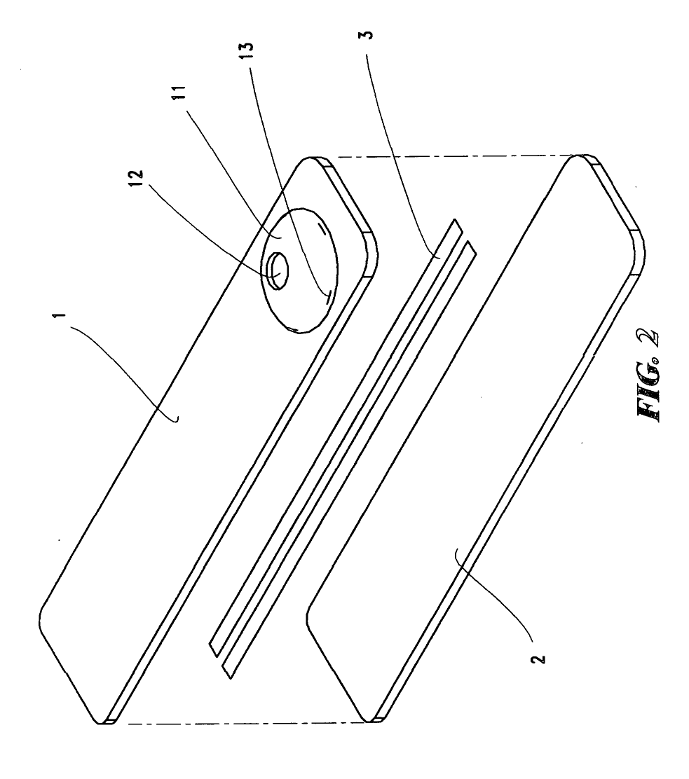

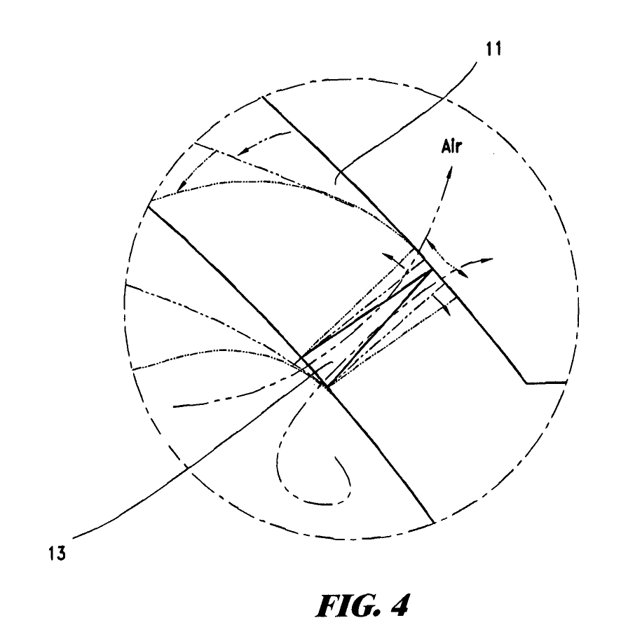

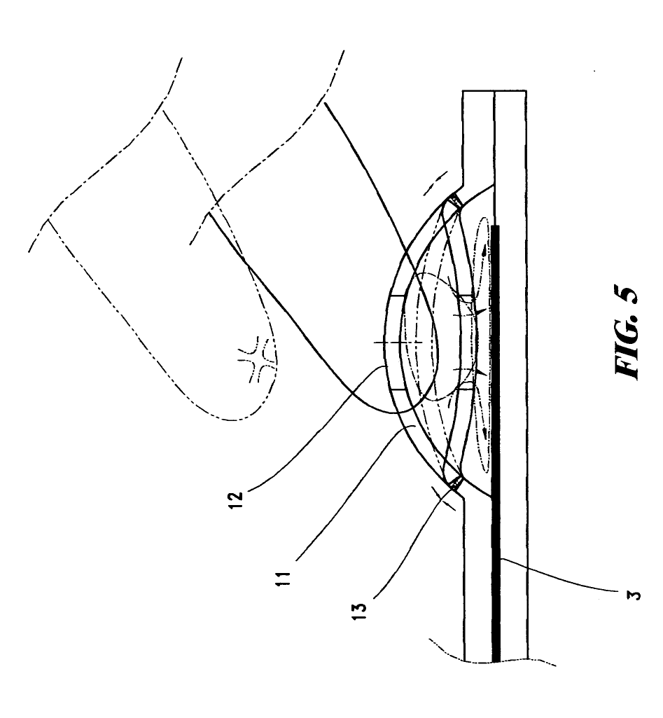

Please refer to FIGS. 1 to 5. The invention of a new structure for test plates to rapidly siphon and transfer the blood, consisting of an upper plate 1, a lower plate 2, and two electrode plates 3; wherein the upper plate 1 is a thin flat plate; a convex arc-shaped press area 11 is located on the front of the upper plate 1; a sucking hole 12 is located on top of the press area 11; several triangular lattices of air holes 13 are built inward and around the external periphery of the sucking hole 12; the lower plate 2 is also a thin flat plate and deemed as the major structure of the invention, and on top of the said plate, placing two electrode plates 3 side by side on the middle so as to unify with upper plate.

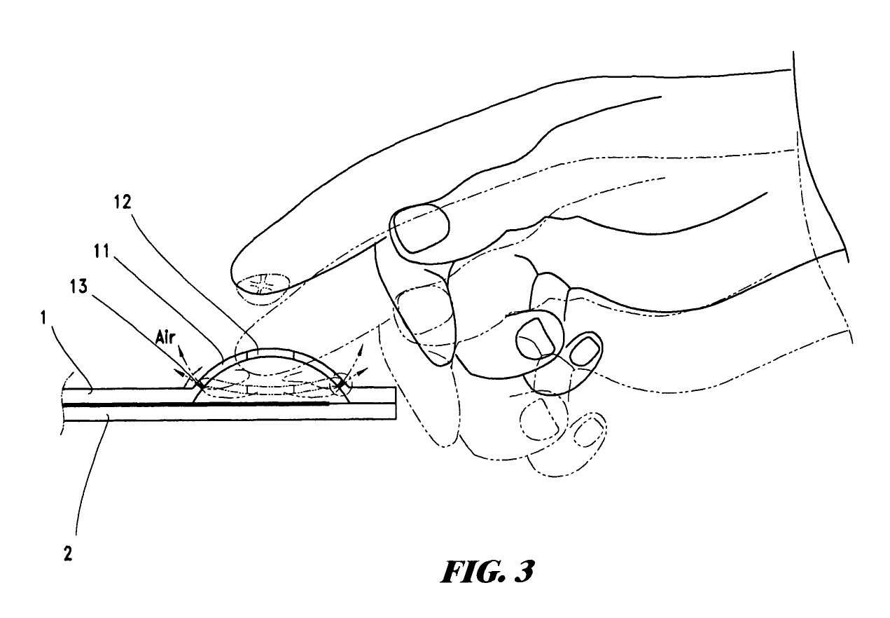

Please refer to FIGS. 3 to 5, and the operating procedure is starting by dropping few drops of blood from fingertip into the sucking hole 12 of the press area, and by pressing the said area 11 to force air out to release the pleasure. By doing so, the triangular lattices of air holes 13 will be pushed open and release the pressure. After the outside and inside pressure is balanced, the hole will close immediately thereafter. This device is helpful by sucking the blood with the vacuum principle so as to siphon and transfer the blood.

With such invention, it is no longer required to wait for blood dropping to transfer automatically into the electrode plates anymore, that by using the vacuum principle, two electrode plates will rapidly siphon the blood to significantly reduce the test time and enhance test accuracy, which in comparison is much better than that of the old structure.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

1. A structure for test plates to rapidly siphon and transfer the blood, consisting of an upper plate, a lower plate, and two electrode plates, and the features including: a convex arc-shaped finger press area located on the front of the upper plate, the said area has a sucking hole on the top with may air holes located around the external periphery. From the above structure, it is suggested to drop few drops of blood into the sucking hole located on the top of the press area that by pressing here to force air out to release pressure. After the outside and inside pressure is balanced, the hole will close immediately thereafter. This device is helpful by sucking the blood with the vacuum principle so as to rapidly siphon and transfer the blood.
